(19) United States
(12) Patent Application Publication
(10) Pub. No.: US 2020/0398395 A1
(43) Pub. Date: Dec. 24, 2020

(54) FIXING MEMBER AND SPINDLE DEVICE

(71) Applicant: FANUC CORPORATION, Minamitsuru-gun (JP)

(72) Inventor: Masahiro MUROTA, Yamanashi-ken (JP)

(21) Appl. No.: 16/898,109

(22) Filed: Jun. 10, 2020

(30) Foreign Application Priority Data
Jun. 21, 2019 (JP) 2019-115280

(51) Int. Cl. B23Q 11/08; B23Q 1/70

(52) U.S. Cl. CPC B23Q 11/0883; B23Q 5/043; B23Q 1/70

(57) ABSTRACT

A spindle device includes: a spindle; a spindle housing having a bearing configured to rotatably support the spindle; a rotating member arranged at one end of the spindle; and a fixing member configured to fix the spindle so that the spindle is unrotatable relative to the spindle housing.

### CROSS-REFERENCE TO RELATED APPLICATION

This application is based upon and claims the benefit of priority from Japanese Patent Application No. 2019-115280 filed on Jun. 21, 2019, the contents of which are incorporated herein by reference.

### BACKGROUND OF THE INVENTION

### Field of the Invention

The present invention relates to a fixing member and a spindle device.

### Description of the Related Art

Japanese Laid-Open Patent Publication No. 2015-188977 discloses a spindle device including a spindle stock having a spindle case, a spindle inserted in the spindle case, and a bearing rotatably supporting the spindle. When such a spindle device is installed at a site such as a factory, the spindle device is transported to the site by using a vehicle or the like.

### SUMMARY OF THE INVENTION

Generally, the spindle of the spindle device is in a rotatable state during transportation. For this reason, there is a risk that the spindle may move irregularly due to external vibrations to which the spindle device is subjected during transportation, causing unintended load on the bearing, which causes disorder such as misalignment of the spindle and damage to the bearing.

It is therefore an object of the present invention to provide a fixing member and a spindle device that can reduce the load on the bearing during transportation.

A first aspect of the present invention resides in a fixing member including: a first attachment portion configured to be attached to a spindle housing having a bearing configured to rotatably support a spindle; and a second attachment portion joined to the first attachment portion and configured to be attached to a rotating member arranged at one end of the spindle, wherein the first attachment portion and the second attachment portion are configured to fix the spindle so that the spindle is unrotatable relative to the spindle housing.

A second aspect of the present invention reside in a spindle device, including: a spindle; a spindle housing having a bearing configured to rotatably support the spindle; a rotating member arranged at one end of the spindle; and a fixing member configured to fix the spindle so that the spindle is unrotatable relative to the spindle housing, wherein the fixing member includes: a first attachment portion configured to be attached to the spindle housing; and a second attachment portion joined to the first attachment portion and configured to be attached to the rotating member.

According to the present invention, since the spindle does not rotate relative to the spindle housing, even if the spindle device is subjected to external vibration during transportation, the load on the bearing during transportation can be reduced.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a perspective view showing a spindle device of the present embodiment;

FIG. 2 is a perspective view showing a state in which part of the spindle device of FIG. 1 is cut out;

FIG. 3 is a view showing a fixing member of FIG. 1;

FIG. 4 is a perspective view showing a fixing member of Modification 1;

FIG. 5 is a perspective view showing a spindle device to which the fixing member of FIG. 4 is attached;

FIG. 6 is a perspective view showing a state in which a fixing member of the embodiment and a fixing member of Modification 1 are used together;

FIG. 7 is a diagram showing a fixing member of Modification 3;

FIG. 8 is a diagram showing a fixing member of Modification 4; and

FIG. 9 is a diagram showing a fixing member of Modification 5.

### DESCRIPTION OF THE PREFERRED EMBODIMENTS

The present invention will be detailed by describing a preferred embodiment with reference to the accompanying drawings.

### Embodiment

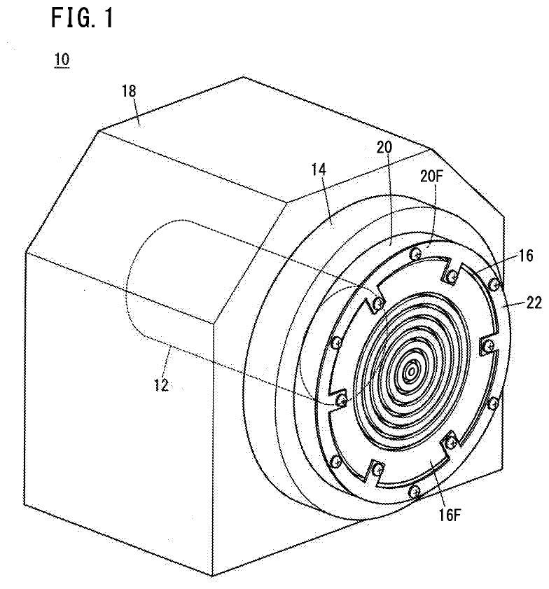

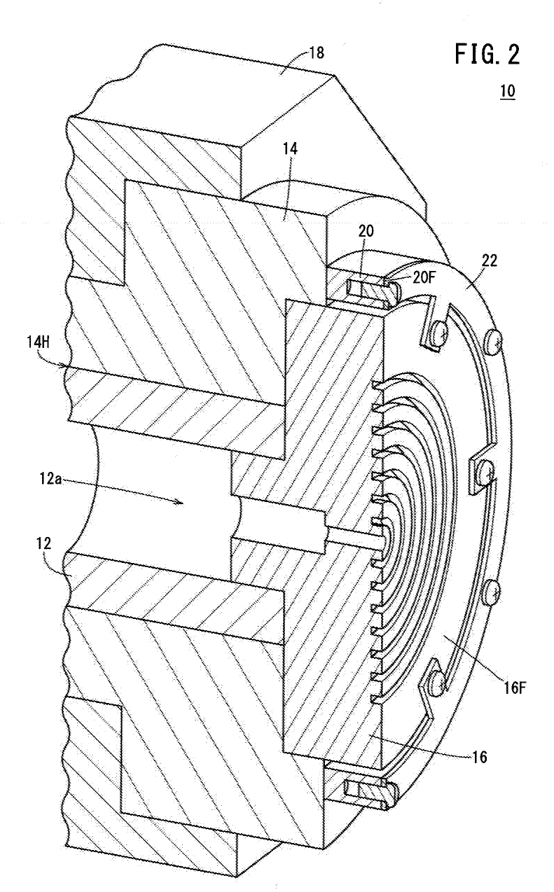

A spindle device 10 according to the present embodiment will be described with reference to FIGS. 1 and 2. The spindle device 10 includes a spindle 12, a spindle housing 14, a rotating member 16, a spindle mounting base 18, an adjusting member 20, and a fixing member 22.

The spindle 12 is a shaft that is rotated by power transmitted from a motor (not shown) that drives the spindle 12. In the example of FIG. 2, a flow passage 12a for flowing a fluid is formed inside the spindle 12, but the flow passage 12a is not essential.

The spindle housing 14 is a housing for accommodating at least the spindle 12. In the illustration of FIG. 2, the detailed structure inside the spindle housing 14 is omitted. The spindle housing 14 includes an insertion hole 14H (see FIG. 2) into which the spindle 12 is inserted, and a bearing (not shown) that rotatably supports the spindle 12 inserted in the insertion hole 14H. The bearing may be a static pressure bearing or a rolling bearing. In a case of controlling the machining on a workpiece at nanometer levels, a static pressure bearing should be preferably used.

The rotating member 16 is a member that is arranged at one end of the spindle 12 and rotates in linkage with the spindle 12, and has a mount face 16F on which a workpiece or tool is attached. The mount face 16F is not covered by the spindle housing 14 but is exposed to outside. In the example of FIGS. 1 and 2, the rotating member 16 is formed in a disc shape, but may have another shape.

The spindle mounting base 18 is a base for mounting the spindle housing 14, and is installed at a predetermined installation location on a site such as a factory. The spindle housing 14 is attached and fixed to the spindle mounting base 18 with fasteners such as bolts. During transportation of the spindle device 10, the spindle housing 14 may be in an attached state to the spindle mounting base 18 or may be in a non-attached state thereto.

The adjusting member 20 is a spacer that adjusts the position of the fixing member 22 relative to the mount face 16F of the rotating member 16 in the axial direction of the spindle 12. The adjusting member 20 is attached and fixed to the spindle housing 14 with fasteners such as bolts, and is arranged between the spindle housing 14 and the fixing member 22.

The adjusting member 20 is used at least when the spindle device 10 is transported. That is, the adjusting member 20 is attached to the spindle housing 14 for transportation. On the other hand, the adjusting member 20 may be attached to the spindle housing 14 or may be detached from the spindle housing 14 at the time of machining a workpiece.

The adjusting member 20 has a mounting surface 20F (see FIG. 2) on which the fixing member 22 is set. In the present embodiment, the adjusting member 20 is formed in a cylindrical shape. One end face of the cylindrical adjusting member 20 is in contact with the spindle housing 14, and the other end face forms the mounting surface 20F.

There may be a difference in level between the mounting surface 20F of the adjusting member 20 and the mount face 16F of the rotating member 16. The adjusting member 20 is preferably configured to adjust the position of the fixing member 22 so that the mounting surface 20F is flush with the mount face 16F of the rotating member 16. Further, when the mount face 16F of the rotating member 16 and the end face of the spindle housing 14 on the front side of the spindle 12 are substantially flush with each other, the adjusting member 20 may be omitted. That is, when the mount face 16F of the rotating member 16 and one end face of the spindle housing 14 are substantially on the same plane, no adjusting member 20 is attached to the spindle housing 14.

The fixing member 22 fixes the spindle 12 to the spindle housing 14 so that the spindle 12 will not rotate relative to the spindle housing. The fixing member 22 may be a metal such as iron or copper, or an alloy containing a metal as a main component, or may be a resin having a relatively high degree of rigidity.

The fixing member 22 is used when the spindle device 10 is transported. That is, the fixing member 22 is attached to the spindle device 10 during transportation in order to fix the spindle 12 in an unrotatable manner to the spindle housing 14. On the other hand, the fixing member 22 is removed from the spindle device 10 when machining, to thereby allow the spindle 12 to rotate relative to the spindle housing 14.

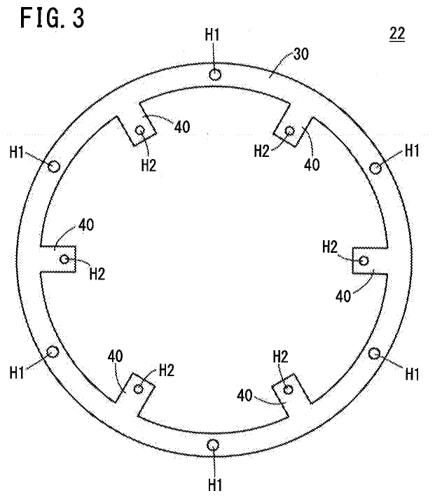

Referring now to FIG. 3, the fixing member 22 will be described. The fixing member 22 is a flat plate as a whole, and has a first attachment portion 30 which is attached to the spindle housing 14 and second attachment portions 40 joined to the first attachment portion 30 and which is attached to the rotating member 16.

In this embodiment, the first attachment portion 30 is formed in an annular shape. The annular shape is not limited to a circular shape as shown in FIG. 3, but may be a shape other than the circular shape. The annular shape may have a discontinuous portion like a Landolt ring, or may have multiple discontinuous portions. That is, as long as the first attachment portion 30 has a ring shape on the whole, it may have one or more discontinuities. In other words, the first attachment portion 30 is formed in at least an arc shape. When the rotating member 16 has a circular annular shape, the first attachment portion 30 may be formed in an arc shape along the arc of the peripheral side surface of the rotating member 16.

The first attachment portion 30 has a plurality of first through holes H1 into which respective fastener are inserted to attach the first attachment portion 30 to the spindle housing 14. A specific example of the fastener includes a bolt. The multiple first through holes H1 are formed at intervals along the circumferential direction of the first attachment portion 30.

As shown in FIGS. 1 and 2, the first attachment portion 30 is fixed to the mounting surface 20F of the adjusting member 20 fixed to the spindle housing 14 by the fasteners being inserted into the respective first through holes H1. Thus, the first attachment portion 30 is attached to the spindle housing 14 via the adjusting member 20. The first attachment portion 30, in a state of being attached to the spindle housing 14, is positioned on a peripheral edge region that lies more outward than the gap between the spindle housing 14 and the rotating member 16. Further, the first attachment portion 30, in a state of being attached to the spindle housing 14, is arranged so as to surround the rotating member 16 when the mount face 16F of rotating member 16 is viewed from the axial direction of the spindle 12.

As shown in FIG. 3, the multiple second attachment portions 40 are arranged at intervals along the circumferential direction of the first attachment portion 30. Here, in this embodiment, the second attachment portions 40 are arranged at approximately equal intervals. The multiple second attachment portions 40 each have a strip shape, for example, extending inwards from the inside edge of the first attachment portion 30 toward the center thereof.

Each of the multiple second attachment portions 40 has a second through hole H2 into which a fastener is inserted to attach the second attachment portion 40 to the rotating member 16. As shown in FIGS. 1 and 2, the multiple second attachment portions 40 are each fixed to the mount face 16F of the rotating member 16 by the fasteners being inserted into the respective second through holes H2. Thus, the multiple second attachment portions 40 are attached to the rotating member 16. In a state of being attached to the rotating member 16, the second attachment portions 40 each extend from the inside edge of the first attachment portion 30 to the mount face 16F of the rotating member 16 so as to extend across the gap between the spindle housing 14 and the rotating member 16.

Here, in this embodiment, each of the multiple second through holes H2 of the second attachment portions 40 is located at a position in the direction in which the corresponding second attachment portion 40 extends, as shown in FIG. 3. On the other hand, the multiple first through holes H1 in the first attachment portion 30 are each displaced in the circumferential direction of the spindle 12, from the second attachment portions 40.

That is, the first through holes H1 where the fastener on the spindle housing 14 side is inserted and fastened and the second through holes H2 where the fastener on the rotating member 16 side is inserted and fastened, are displaced (shifted) from each other in the circumferential direction of the spindle 12. Therefore, as shown in FIGS. 1 and 2, the positions of insertion of the fasteners are disposed alternately on the outer side and the inner side with reference to the circumferential gap between the spindle housing 14 and rotating member 16 in the circumferential direction of the spindle 12 (i.e., in a staggered manner in the circumferential direction). This arrangement makes it easier to distribute force acting on the fixing member 22 as compared to the case where the first through holes H1 and the second through holes H2 are not shifted from each other in the circumferential direction of the spindle 12.

As explained with reference to FIGS. 1 to 3, in the present embodiment, when the spindle device 10 is transported, the first attachment portion 30 of the fixing member 22 is attached to the spindle housing 14 while the second attachment portions 40 of the fixing member 22 are attached to the rotating member 16. Therefore, even if the spindle device 10 is subjected to external vibrations during transportation, the spindle 12 is prevented from rotating via the rotating member 16, and as a result, it is possible to reduce the load on the bearing that supports the spindle 12 during transportation.

In addition, in the present embodiment, the first attachment portion 30 is formed in an annular shape, and the second attachment portions 40 are joined to the first attachment portion 30, and arranged at intervals along the circumferential direction of the first attachment portion 30. This configuration makes it possible to improve the resistance of the fixing member 22 against external vibrations acting on the spindle device 10.

Further, in the present embodiment, the fixing member 22 is flat as a whole while the second attachment portions 40 extend inwards from the first attachment portion 30 toward the center of the first attachment portion 30 and are attached to the mount face 16F of the rotating member 16. This makes it possible to suppress misalignment (off-center) of the spindle 12 (prevent the axial position of the spindle 12 from being deviated radially) due to external vibrations acting on the spindle device 10.

Moreover, in the present embodiment, the adjusting member 20 for adjusting the position of the fixing member 22 relative to the mount face 16F of the rotating member 16 in the axial direction of the spindle 12 is disposed between the spindle housing 14 and the fixing member 22. This arrangement enables attachment of the flat fixing member 22 without being deformed even if there is a relatively large difference in level between the spindle housing 14 and the mount face 16F of the rotating member 16 in the axial direction of the spindle 12.

Incidentally, there are cases where a relatively small level difference occurs between the mount face 16F of the rotating member 16 and the mounting surface 20F of the adjusting member 20, due to the tolerances of the spindle housing 14, the adjusting member 20, and others, in the spindle device 10. For example, there occurs a slight level difference (step) between the mount face 16F of the rotating member 16 and the mounting surface 20F of the adjusting member 20, due to the tolerance of the spindle device 10. When the second attachment portions 40 have resiliency in the axial direction of the spindle 12, the resiliency of the second attachment portions 40 allows moderate deformation in the axial direction of the spindle 12. As a result, even if there occurs a slight step between the mount face 16F of the rotating member 16 and the mounting surface 20F of the adjusting member 20, due to the tolerance of the spindle device 10, the flat fixing member 22 can be attached without excessively pressing against the spindle 12.

Further, in the present embodiment, the first attachment portion 30 is attached to the spindle housing 14 by the fasteners such as bolts that are inserted into the first through holes H1 while the second attachment portions 40 are attached to the rotating member 16 by the fasteners such as bolts that are inserted into the second through holes H2. With this configuration, it is possible to prevent the fixing member 22 from coming off due to external vibrations acting on the spindle device 10 during transportation.

### Modifications

Though the above embodiment has been described as one example of the present invention, the technical scope of the invention should not be limited to the above embodiment. It goes without saying that various modifications and improvements can be added to the above embodiment. It is also apparent from the scope of claims that the embodiment added with such modifications and improvements should be incorporated in the technical scope of the invention. Examples in which modifications and improvements are added to the above embodiment will be described hereinbelow.

### Modification 1

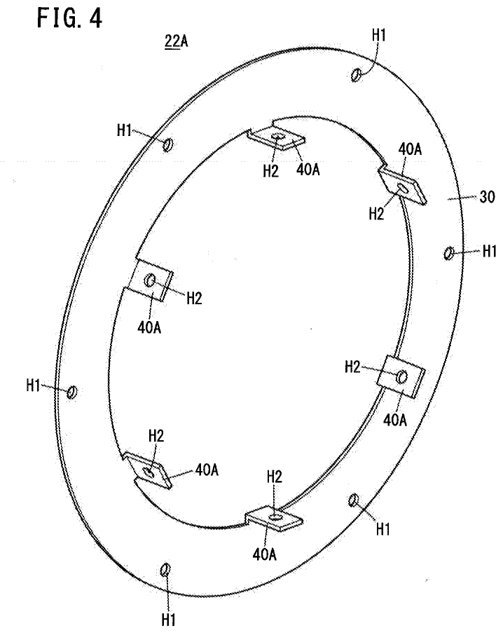

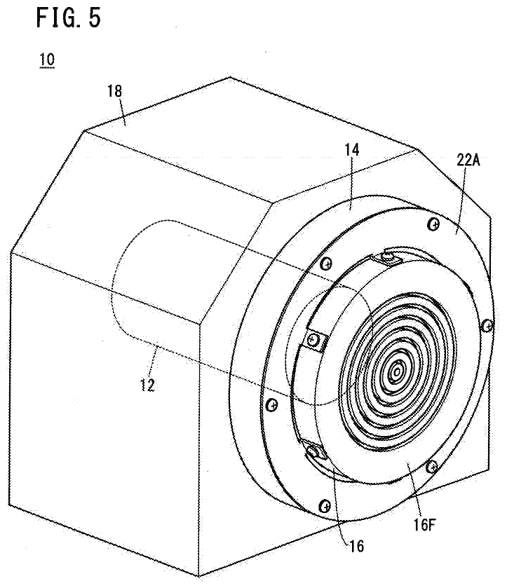

A spindle device 10 according to Modification 1 will be described with reference to FIGS. 4 and 5. In FIGS. 4 and 5, the same components as those described in the above embodiment are allotted with the same reference numerals. Here, in the explanation of this Modification, description that is included in that of the above embodiment will be omitted.

The spindle device 10 of Modification 1 does not have the adjusting member 20 (see FIG. 5) and is provided with a fixing member 22A (see FIG. 4) in place of the fixing member 22 of the above embodiment. The fixing member 22A includes the first attachment portion 30 of the above embodiment and multiple second attachment portions 40A disposed at intervals along the circumferential direction of the first attachment portion 30. Here, in this Modification the second attachment portions 40A are arranged at approximately equal intervals.

The first attachment portion 30 is attached to the spindle housing 14 with the adjusting member 20 interposed therebetween in the above embodiment, whereas it is attached directly to the spindle housing 14 with no adjusting member 20 interposed, in this Modification. That is, in this Modification, as shown in FIG. 5, the first attachment portion 30 is attached to the spindle housing 14 by being fixed to an end surface of the spindle housing 14 on the front end side of the spindle 12, more specifically to its peripheral area that lies more outward than the gap between the spindle housing 14 and the rotating member 16, by means of fasteners being inserted into the multiple first through holes H1.

As shown in FIG. 4, each of the multiple second attachment portions 40A is a flat plate, and extends from the first attachment portion 30 in a direction crossing the flat first attachment portion 30. Each second attachment portion faces the peripheral side surface of the rotating member 16 as shown in FIG. 5 in a state of being attached to the rotating member 16. In the example shown in FIGS. 4 and 5, each of the multiple second attachment portions 40A extends perpendicularly to the flat first attachment portion 30, and faces the peripheral side surface of the rotating member 16 in parallel with each other, in a state of being attached to the rotating member 16.

Since the multiple second attachment portions 40A each extend in a direction crossing the flat first attachment portion 30, the fixing member 22A of this Modification is not a flat plat as a whole, though each of the first attachment portion 30 and the second attachment portions 40A are flat individually. The fixing member 22 of the above embodiment may be used as the fixing member 22A of the modification, by bending the second attachment portions 40 of the fixing member 22.

The multiple second attachment portions 40A are each fixed to the peripheral side surface of the rotating member 16 by the fasteners being inserted into the respective second through holes H2. Thus, the multiple second attachment portions 40A are attached to the rotating member 16.

As explained with reference to FIGS. 4 and 5, in this Modification, the multiple second attachment portions 40A each extend from the flat first attachment portion 30 in a direction crossing the first attachment portion 30 and are attached to the peripheral side surface of the rotating member 16.

Therefore, similarly to the above embodiment, it is possible to suppress misalignment (off-center) of the spindle 12 due to external vibrations acting on the spindle device 10. Further, even if there is a relatively large level difference between the spindle housing 14 and the mount face 16F of the rotating member 16 in the axial direction of the spindle 12, this arrangement enables attachment of the second attachment portions 40A to the rotating member 16 without use of the adjusting member 20.

### Modification 2

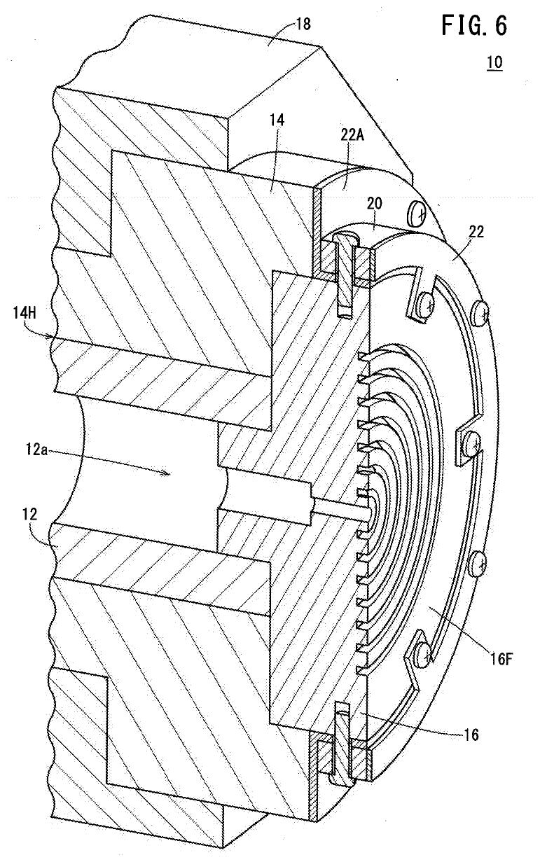

Both the fixing member 22 of the embodiment and the fixing member 22A of Modification 1 may be used respectively as the first and second fixing members. Specifically, as shown in FIG. 6, the fixing member 22A (second fixing member) is mounted on the end face of the spindle housing 14 on one end side (the front side) of the spindle 12, the adjusting member 20 is placed on the fixing member 22A, and the fixing member 22 (first fixing member) is mounted on the adjusting member 20.

When the fixing member 22 and the fixing member 22A are thus used in combination, the spindle 12 can be fixed more firmly to the spindle housing 14 as compared to a case in which only one of the fixing member 22 and the fixing member 22A is used.

### Modification 3

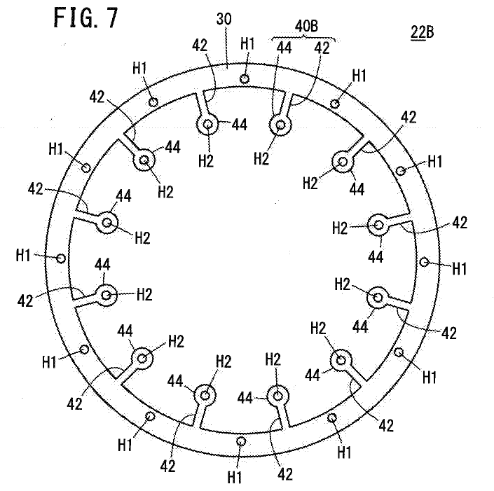

A fixing member 22B of Modification 3 will be described with reference to FIG. 7. In FIG. 7, the same components as those described in the above embodiment are allotted with the same reference numerals. In the description of this Modification, the description included in that of the above embodiment is omitted.

The fixing member 22B of this Modification is different from the fixing member 22 of the above embodiment in that multiple second attachment portions 40B having a different shape from that of the second attachment portions 40 of the embodiment are used. Each of the multiple second attachment portions 40B includes an arm 42 extending from the first attachment portion 30 toward the center of the first attachment portion 30, and an arm end 44 formed at the end of the arm 42 opposite from the first attachment portion 30 side. Each arm end 44 is formed with a second through hole H2.

Each of the arms 42 of the second attachment portions 40B is formed into a strip shape so as to have a width smaller than the outside diameter of the annular arm end 44. In other words, each of the second attachment portions 40B has the arm 42 as a constricted portion. Therefore, the second attachment portions 40B are prone to deform in the axial direction of the spindle 12 as compared to the second attachment portions 40 of the above embodiment which have no constricted portion. As a result, the flat fixing member 22B can be attached without excessively pressing against the spindle 12.

The second attachment portions 40B of this Modification may be used to replace the second attachment portions 40A in the fixing member 22A of the above Modification 1.

### Modification 4

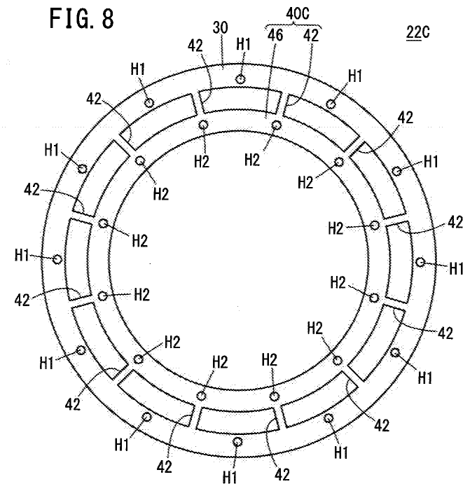

A fixing member 22C of Modification 4 will be described with reference to FIG. 8. In FIG. 8, the same components as those described in the above embodiment are allotted with the same reference numerals. In the description of this Modification, the description included in that of the above embodiment is omitted.

The fixing member 22C of this Modification is different from the fixing member 22 of the above embodiment in that a second attachment portion 40C having a different shape from that of the second attachment portions 40 of the embodiment is used. The second attachment portion 40C includes multiple arms 42 extending from the first attachment portion 30 toward the center of the first attachment portion 30, and a one-piece arm end 46 that is joined to ends of the multiple arms 42 opposite from the first attachment portion 30 side.

Each of the multiple arms 42 is formed in a strip shape while the one-piece arm end 46 is formed in an annular shape. The annular shape is not limited to a circular shape as shown in the drawing, but may be a shape other than the circular shape. The annular shape may have a discontinuous portion like a Landolt ring, or may have multiple discontinuous portions. That is, as long as the annular arm end 46 has a ring shape on the whole, it may have one or more discontinuities.

The annular one-piece arm end 46 is disposed on the inner side of the annular first attachment portion 30. The arm end 46 has multiple second through holes H2 formed at intervals along the circumferential direction of the annular one-piece arm end 46. Here, in the example of FIG. 8, the multiple second through holes H2 and the multiple first through holes H1 are arranged so as to be shifted from each other in the circumferential direction of the spindle 12, but may be arranged so as to be aligned with each other. When the multiple second through holes H2 and the multiple first through holes H1 are shifted from each other in the circumferential direction of the spindle 12, force acting on the fixing member 22C is easy to be distributed suitably, similarly to the above embodiment.

In this way, the second attachment portion 40C of this Modification includes multiple strip-shaped arms 42 extending from the first attachment portion 30 and the annular one-piece arm end 46 to which each of the multiple arms 42 is joined. This configuration of the modification enlarges the area of contact with the rotating member 16 as compared to the above embodiment. Hence, it is possible to fix the spindle 12 to the spindle housing 14 more firmly.

### Modification 5

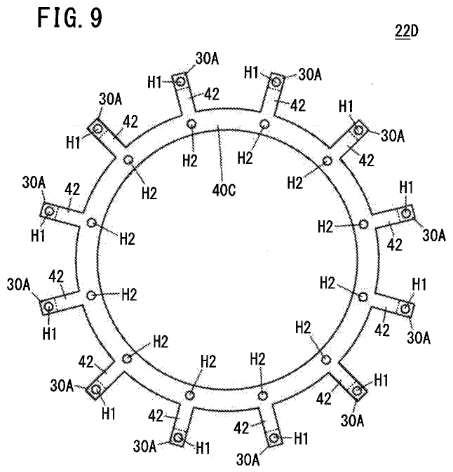

A fixing member 22D of Modification 5 will be described with reference to FIG. 9. In FIG. 9, the same components as those described in Modification 4 are allotted with the same reference numerals. In the description of this Modification, the description included in that of Modification 4 is omitted.

The fixing member 22D of this Modification is different from the fixing member 22C of Modification 4 in that first attachment portions 30A of a shape different from the first attachment portion 30 of Modification 4 is used. Each of the first attachment portions 30A is formed in a strip shape so as to have the same width as that of the strip-shaped arm 42 of the second attachment portion 40C.

With this fixing member 22D of Modification 5 also, similarly to the above embodiment, it is possible to reduce the load on the bearing during transpiration even if external vibration acts on the spindle device 10 during transportation.

Here, the first attachment portions 30A of the fixing member 22D of Modification 5 may adopt the configuration of the first attachment portions 30 of the above embodiment.

### Modification 6

In the above embodiment, the multiple second attachment portions 40 are arranged at approximately equal intervals in the circumferential direction of the spindle 12. However, it is not essential that the second attachment portions 40 are arranged at approximately equal intervals. For example, the intervals between adjacent second attachment portions 40 may differ on one side (upper side) and the other side (lower side), with a horizontal plane including the axis of the spindle 12 as a boundary, or may differ on one side (left side) and the other side (right side) with a vertical plane orthogonal to the horizontal plane as a boundary. By making the intervals different in this way, it is possible to vary the rigidity and flexibility of the fixing member 22 between one side and the other side with the horizontal or vertical plane as a boundary.

### Modification 7

In the above embodiment, fasteners such as bolts are used to attach and fix the fixing member 22 to the spindle housing 14 and the rotating member 16. However, the fixing member 22 may be attached and fixed to the spindle housing 14 and the rotating member 16 with an adhesive or the like.

### Modification 8

Though the fixing member 22 includes a plurality of the second attachment portions 40 in the above embodiment, only one second attachment portion 40 may be provided instead.

### Modification 9

Other than the above, the embodiment and the modifications may be arbitrarily combined as long as no technical inconsistency occurs.

### Inventions Obtained from the Above

Inventions that can be understood from the above-described embodiments and modifications will be described below.

### First Invention

The first invention is a fixing member (22, 22A), which includes: a first attachment portion (30) configured to be attached to a spindle housing (14) having a bearing that rotatably supports a spindle (12); and a second attachment portion (40, 40A) joined to the first attachment portion (30) and configured to be attached to a rotating member (16) arranged at one end of the spindle (12), wherein the first attachment portion (30) and the second attachment portion (40, 40A) are configured to fix the spindle (12) so that the spindle is unrotatable relative to the spindle housing (14).

With this configuration, the spindle (12) does not rotate relative to the spindle housing (14), and it is hence possible to reduce the load on the bearing during transportation even if the spindle device (10) is subjected to external vibrations during transportation.

The first attachment portion (30) may be formed in a circular arc-shape, and the second attachment portions (40, 40A) may be joined to the first attachment portion (30) and arranged at intervals in the circumferential direction of the first attachment portion (30). This configuration can improve the resistance of the fixing member (22, 22A) against external vibrations acting on the spindle device (10).

The fixing member (22) may be a flat plate, and the second attachment portion (40) may be configured to extend from the first attachment portion (30) toward the center of the first attachment portion (30) and be attached to a mount face (16F) of the rotating member (16) to which a workpiece or a tool is set. This configuration makes it possible to suppress misalignment (off-center) of the spindle (12) (prevent the axial position of the spindle (12) from being deviated radially) due to external vibrations acting on the spindle device (10).

The second attachment portion (40) may have resiliency in the axial direction of the spindle (12). This allows the fixing member to deform appropriately in the axial direction of the spindle (12). As a result, even if a slight difference in level occurs between the mount face (16F) of the rotating member (16) and the spindle housing (14) due to the tolerance of the spindle device (10), the flat fixing member (22) can be attached.

Each of the first attachment portion (30) and the second attachment portion (40A) may be a flat plate, and the second attachment portion (40A) may be configured to extend from the first attachment portion (30) in a direction that crosses the first attachment portion (30), and be attached to the peripheral side surface of the rotating member (16). This configuration can suppress misalignment (off-center) of the spindle (12) due to external vibrations acting on the spindle device (10). Additionally, even if there is a relatively large level difference between the spindle housing (14) and the mount face (16F) of the rotating member (16) in the axial direction of the spindle (12), this arrangement enables attachment of the second attachment portions (40A) to the rotating member (16).

The first attachment portion (30) may have a first through hole (H1) into which a fastener is inserted to attach the first attachment portion (30) to the spindle housing (14), and the second attachment portion (40, 40A) may have a second through hole (H2) into which a fastener is inserted to attach the second attachment portion (40, 40A) to the rotating member (16). With this configuration, it is possible to prevent the fixing member (22, 22A) from coming off due to external vibrations acting on the spindle device (10) during transportation.

The position of the first through hole (H1) and the position of the second through hole (H2) may be shifted from each other in the circumferential direction of the spindle (12). This arrangement makes it easy to distribute force acting on the fixing member (22, 22A).

### Second Invention

The second invention is a spindle device (10), which includes: a spindle (12); a spindle housing (14) having a bearing configured to rotatably support the spindle (12); a rotating member (16) arranged at one end of the spindle (12); and a fixing member (22, 22A) configured to fix the spindle (12) so that the spindle (12) is unrotatable relative to the spindle housing (14). The fixing member (22, 22A) includes: a first attachment portion (30) configured to be attached to the spindle housing (14); and a second attachment portion (40, 40A) joined to the first attachment portion (30) and configured to be attached to the rotating member (16).

In the configuration, the spindle (12) is fixed so as not to rotate relative to the spindle housing (14), and thus it is possible to reduce the load on the bearing during transportation even if the spindle device (10) is subjected to external vibrations during transportation.

The fixing member (22) may be a flat plate, the first attachment portion (30) may be formed in a circular arc-shape, and the second attachment portions (40) may be joined to the first attachment portion (30) and arranged at intervals in the circumferential direction of the first attachment portion (30), and each of the second attachment portions (40) is configured to extend from the first attachment portion (30) toward the center of the first attachment portion (30), and be attached to a mount face (16F) of the rotating member (16) to which a workpiece or a tool is set. This configuration can improve the resistance of the fixing member (22) against external vibrations acting on the spindle device (10). Further, it is possible to suppress misalignment (off-center) of the spindle (12) due to external vibrations acting on the spindle device (10).

The spindle device may further include an adjusting member (20) arranged between the spindle housing (14) and the fixing member (22), and configured to adjust the position of the fixing member (22) in the axial direction of the spindle (12), relative to the mount face (16F) of the rotating member (16). This arrangement enables attachment of the second attachment portions (40) to the rotating member (16) even if there is a relatively large step (difference in level) between the spindle housing (14) and the mount face (16F) of the rotating member (16) in the axial direction of the spindle (12).

Each of the first attachment portion (30) and the second attachment portions (40A) may be a flat plate, the first attachment portion (30) may be formed in a circular arc-shape, and the second attachment portions (40A) may be joined to the first attachment portion (30) and arranged at intervals in the circumferential direction of the first attachment portion (30), and each of the second attachment portions (40A) may be configured to extend from the first attachment portion (30) in a direction that crosses the first attachment portion (30), and be attached to the peripheral side surface of the rotating member (16). This configuration can improve the resistance of the fixing member (22A) against external vibrations acting on the spindle device (10). Further, it is possible to suppress misalignment (off-center) of the spindle (12) due to external vibrations acting on the spindle device (10). Additionally, this arrangement enables attachment of the second attachment portions (40A) to the rotating member (16) even if there is a relatively large step between the spindle housing (14) and the mount face (16F) of the rotating member (16) in the axial direction of the spindle (12).

What is claimed is:

1. A fixing member comprising:
a first attachment portion configured to be attached to a spindle housing having a bearing configured to rotatably support a spindle; and
a second attachment portion joined to the first attachment portion and configured to be attached to a rotating member arranged at one end of the spindle,
wherein the first attachment portion and the second attachment portion are configured to fix the spindle so that the spindle is unrotatable relative to the spindle housing.

2. The fixing member according to claim 1, wherein:
the first attachment portion is formed in a circular arc-shape; and
the second attachment portions are joined to the first attachment portion and arranged at intervals in a circumferential direction of the first attachment portion.

3. The fixing member according to claim 1, wherein:
the fixing member is a flat plate; and
the second attachment portion is configured to extend from the first attachment portion toward a center of the first attachment portion and be attached to a mount face of the rotating member to which a workpiece or a tool is set.

4. The fixing member according to claim 3, wherein the second attachment portion has resiliency in an axial direction of the spindle.

5. The fixing member according to claim 1, wherein:
each of the first attachment portion and the second attachment portion is a flat plate; and
the second attachment portion is configured to extend from the first attachment portion in a direction that crosses the first attachment portion, and be attached to a peripheral side surface of the rotating member.

6. The fixing member according to claim 1, wherein:
the first attachment portion has a first through hole into which a fastener is inserted to attach the first attachment portion to the spindle housing; and
the second attachment portion has a second through hole into which a fastener is inserted to attach the second attachment portion to the rotating member.

7. The fixing member according to claim 6, wherein a position of the first through hole and a position of the second through hole are shifted from each other in a circumferential direction of the spindle.

8. A spindle device, comprising:
a spindle;
a spindle housing having a bearing configured to rotatably support the spindle;
a rotating member arranged at one end of the spindle; and
a fixing member configured to fix the spindle so that the spindle is unrotatable relative to the spindle housing,
wherein the fixing member includes:
a first attachment portion configured to be attached to the spindle housing; and
a second attachment portion joined to the first attachment portion and configured to be attached to the rotating member.

9. The spindle device according to claim 8, wherein:
the fixing member is a flat plate;
the first attachment portion is formed in a circular arc-shape; and
the second attachment portions are joined to the first attachment portion and arranged at intervals in a circumferential direction of the first attachment portion, and each of the second attachment portions is configured to extend from the first attachment portion toward a center of the first attachment portion, and be attached to a mount face of the rotating member to which a workpiece or a tool is set.

10. The spindle device according to claim 9, further comprising an adjusting member arranged between the spindle housing and the fixing member and configured to adjust a position of the fixing member in an axial direction of the spindle, relative to the mount face of the rotating member.

11. The spindle device according to claim 8, wherein:
each of the first attachment portion and the second attachment portion is a flat plate;
the first attachment portion is formed in a circular arc-shape; and
the second attachment portions are joined to the first attachment portion and arranged at intervals in a circumferential direction of the first attachment portion, and each of the second attachment portions is configured to extend from the first attachment portion in a direction that crosses the first attachment portion, and be attached to a peripheral side surface of the rotating member.
